(19) United States
(12) Patent Application Publication
(10) Pub. No.: US 2013/0078439 A1
(43) Pub. Date: Mar. 28, 2013

(54) STRUCTURE OF FIBER-REINFORCED COMPOSITE MATERIAL-MADE COMPONENT PART, AND PRODUCTION METHOD FOR THE COMPONENT PART

(71) Applicant: Natsuhiko Katahira, Toyota-shi (JP)

(72) Inventor: Natsuhiko Katahira, Toyota-shi (JP)

(21) Appl. No.: 13/701,044

(22) PCT Filed: Jun. 1, 2011
(86) PCT No.: PCT/IB2011/001204

§ 371 Date: Nov. 30, 2012

(30) Foreign Application Priority Data
Jun. 3, 2010 (JP) 2010-127815

(51) Int. Cl. B29C 70/48

(52) U.S. Cl. CPC B29C 70/48
USPC 428/212; 264/257

(57) ABSTRACT

There is provided a component part (1) made up of a tubular skeleton member (1B) that is formed by a structural material-purpose reaction injection molding of a thermoplastic resin reinforced by a continuous fiber and that is enhanced in rigid strength, and projection-and-depression structures (1A, 1C) that cover two end openings of the tubular skeleton member and that are made of a thermoplastic resin that is of the same family as and is highly compatible with the foregoing thermoplastic resin. In the production method for the component part (1), before the thermoplastic resin used in the structural material-purpose reaction injection molding finishes polymerizing, the thermoplastic resin is injected to a mold cavity that surrounds the tubular skeleton member (1B), so that the component part (1) having high rigid strength is efficiently produced.

### BACKGROUND OF THE INVENTION

1. Field of the Invention

The invention relates to a structure of a component part that contains a fiber-reinforced composite material, and a production method for the component part. More particularly, the invention relates to a structure of a component part made by integrating, by injection molding, a skeleton member made of a fiber-reinforced plastic (hereinafter, abbreviated as “FRP”) which is formed by a structural reaction injection molding (hereinafter, abbreviated as “SRIM”) process, and a member that covers the skeleton member. The invention also relates to a production method for the component part.

2. Description of the Related Art

Japanese Patent Application Publication No. 10-138354 (JP-A-10-138354) and Japanese Patent No. 4023515 show a structure that contains a thermoplastic resin, and a method of integrally forming an FRP that contains a thermosetting resin. Firstly, a thermoplastic resin film is layered on an FRP that is made up of a thermosetting resin and a reinforcement fiber for increasing the rigid strength.

Then, under a temperature condition for hardening the thermosetting resin is hardened and for causing the resin of the thermoplastic resin film to flow, the FRP coated with the thermoplastic resin film is made into a desired shape by hot press,

After that, the FRP having a desired shape is disposed in a mold cavity, and is subjected to injection molding by injecting a thermoplastic resin toward the thermoplastic resin film layered on the FRP. Thus, a structure of a component part in which the FRP and the thermoplastic resin are adhered integrally to each other by causing the thermoplastic resin film to function as a adhesion under the temperature condition in which the thermoplastic resin film flows.

### SUMMARY OF THE INVENTION

However, the related-art methods have problems as follows. First, the strength of the adhesion interface between the thermosetting resin that is the resin of the FRP and the thermoplastic resin of the resin film sheet tends to be insufficient. Second, the method is not suitable for a component part that has a complicated projection-and-depression shape, for example, bosses, ribs, etc. Third, the method achieves only low productivity of the component part. Fourth, the recyclability of the materials of the component part is low.

The first problem is attributed to the use of different kinds of resins, that is, the thermosetting resin and the thermoplastic resin, that are opposite to each other in the thermal behavior exhibited up to the hardening. In order to solve this problem, it is conceivable to activate the surface of a thermoplastic resin film (insert member), or apply to a gap between the thermosetting resin and the thermoplastic resin film an adhesive that has adhesion compatibility. However, these methods require an additional facility or additional process step, and need another adhesive and therefore increases the cost although it is preferable that the adhesion be completed by utilizing the thermoplastic resin film.

The second problem does not arise if a base material surface to which the thermoplastic film is stuck is relatively flat, However, if there is a projection-and-depression structure, such as bosses, ribs, etc., the thermoplastic film that is once closely attached to the base material surface at a bend portion or an inflection portion (round portion) of the projection-and-depression structure separates from the base material surface or forms wrinkles. Besides, if such separations or wrinkles of the film develop, the thermoplastic film peels off. As for the third problem, while the injection molding of the thermoplastic resin achieves very good productivity in .forming a projection-and depression structure, such as bosses, ribs, etc.,. the molding of a laminate type thermosetting FRP requires considerable human labor in the layer stacking operation. Besides, generally, the time needed for the hardening of the thermosetting resin by cross-linking reaction is longer than the time needed for the cooling and solidification of the thermoplastic resin. Thus, low productivity results.

As for the fourth problem, while the thermoplastic resin can be shredded into pieces and recycled, the thermosetting resin, once hardened, does not readily soften even if it is shredded and heated. This is because the thermosetting resin undergoes resin hardening by irreversible reaction. Therefore, if the resin of an FRP is a thermosetting resin, the FRP cannot be recycled. Consequently, the FRP whose resin is a thermosetting resin cannot but be disposed of, and thus requires a waste cost.

Accordingly, the invention provides a structure of a fiber-reinforced composite material-made component part in which a thermoplastic resin is used as a resin.

of an FRP at a site where excellent rigid strength is required, and a thermoplastic resin of the same family as the thermoplastic resin is used at a site of a complicated structure, for example, a projection-and-depression structure such as bosses, ribs, etc., and in which a simple-shape skeleton member containing the FRP and formed by the SRIM process and a member having a complicated shape, for example, bosses, ribs, etc., but not necessarily needing strength are integrated together by injection molding so as to increase the rigid strength, and which achieves improved productivity of the component part, and the invention also provides a production method for the fiber-reinforced composite material-made component part.

A first aspect of the invention relates to a structure in which a skeleton member that is molded by a first injection molding process and that is made of a first thermoplastic resin that is reinforced by a continuous fiber contained in the first thermoplastic resin, and a member that covers the skeleton member and that is made of a second thermoplastic resin that has weldability with the first thermoplastic resin are integrated by a second injection molding process.

In the component part in accordance with the invention, the first injection molding process may be a reaction injection molding process for a structural material, and the second thermoplastic resin may have high weldability with the first thermoplastic resin.

According to the foregoing constructions, the member reinforced by the continuous fiber and the injection-molded member are made of weldable resins of the same family, that, is, thermoplastic resins. Since the two resins of the same family are compatible with each other, and therefore weldable with each other, there is no possibility of the strength becoming insufficient because adhesion is not preferably performed at the interface between resins of different families as in the related-art technology when the two members are welded at the time of injection molding. Besides, since the member reinforced by the continuous fiber is produced directly by the structural material-purpose reaction injection molding (RUM) of a woven-type fiber and a thermoplastic resin, the process step of fabricating a prepreg sheet beforehand can be eliminated. Besides, since there is no need for a thermoplastic resin film that serves as an adhesive, the problem of local separations or wrinkles at the sites of complicated shapes attributed to the thermoplastic resin film does not arise. Besides, generally in the structure of the SRIM component part of a thermoplastic resin represented by PA6, the polymerization time of the thermoplastic resin is very short compared with the hardening time of the thermosetting resin, so that high productivity is achieved. Furthermore, since the component part is fowled entirely from the thermoplastic resin, the component part can be reused or recycled.

In the component part in accordance with the invention, the first thermoplastic resin may be PA6, and the second thermoplastic resin may be a polyamide-based thermoplastic resin that has weldability with PA6 and that is lower in water absorbency than PA6. PA6 has advantages of being excellent in moldability by the SRIM process and being relatively inexpensive. However, PA6 is relatively high in water absorbency, and when PA6 absorbs water, the rigid strength thereof declines or the dimensions thereof change. Therefore, PA6 cannot be used for a component part about which a change in the physical property due to water absorption becomes a problem. Therefore, according to the foregoing construction, if the skeleton member is made by the molding of PA6 and a tubular fiber by the SRIM process and one of PA66 and PA46, which are weldable with PA6 and are low in water absorbency, is injected into the mold so that a projection-and-depression structure is formed and integrated with the skeleton member, it is possible to obtain a component part at relatively low cost without a possibility of occurrence of a defect or the like even in the case where water absorbency can become a problem.

In the component part in accordance with the invention, the second thermoplastic resin may have compatibility with the first thermoplastic resin.

A second aspect of the invention relates to a method of producing a fiber-reinforced composite material-made component part in which a skeleton member that is formed by a first injection molding process and that is made by impregnating a tubular fiber with a first thermoplastic resin, and a projection-and-depression structure that contains a second thermoplastic resin are integrated together by a second injection molding process. This method includes performing the second injection molding process immediately subsequently to molding of the skeleton member by the first injection molding process so that a polymerization reaction time of the first thermoplastic resin is contained in a time that is needed for the first injection molding process and the second injection molding process.

Generally, the structural material-purpose reaction injection molding (SRIM) of a thermoplastic resin and the injection molding of the same thermoplastic resin differ in the molding time. That is, of the solidification time of the polymerization reaction of a monomer and the cooling solidification time of a polymer, the cooling solidification time of the polymer is the shorter. Therefore, in some production methods according to the related art, it is possible to produce a skeleton member in the SRIM process step as a separate lot and convey the produced skeleton member into an injection molding step in which the skeleton member is heated in order to secure weldability and the heated skeleton member is set in the mold for injection molding, and then is subjected to injection molding. However, in this production method, an idle time occurs in the injection molding step, or an extra step of heating the skeleton member, or the like is needed, and therefore high efficiency is not necessarily achieved.

According to the foregoing construction of the invention, because the injection molding is performed immediately subsequently to the molding by the SRIM process, before the polymerization reaction of the thermoplastic resin caused by the SRIM process is completed, that. is, before the change to larger molecules considerably progresses, the time required for the injection molding Can be contained within the polymerization time while the temperature condition needed for the polymerization reaction (change to larger molecules) is maintained. Therefore, the entire lead time involved in the production of the component part is reduced, and there is no substantial decline in the temperature of the member after the member is molded by the SRIM process.. Hence, it is possible to achieve a very highly efficient production that does not require the heating of the skeleton member in a separate process step in order to secure weldability.

According to the structure of the component part in accordance with the invention, since the skeleton member containing an FRP Which is formed by the SRIM process and the non-skeleton member that includes portions of relatively complicated shapes, such as bosses, ribs, etc., can be integrated by injection molding, it is possible to provide a component part having high rigid strength. Besides, according to the production method for the component part in accordance with the invention, since the FRP-containing skeleton member that is formed by the SRIM process and the non-skeleton member that includes portions of relatively complicated shapes, such as bosses, ribs, etc., can be integrated by injection molding, it is possible to highly efficiently produce a component part of high rigid strength without a need to use an adhesive.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1A shows a perspective view of a component part in which a plate, a flange and a tube are integrated; and FIG. 1B shows an exploded perspective view of the plate, the tube, and the flange that is fixed to another member;

FIG. 2 is a schematic sectional view concerning a first step in a production method for the component part shown in FIG. 1;

FIG. 3 is a schematic sectional view concerning a .second step in the production method;

FIG. 4 is a schematic sectional view concerning a third step in the production method;

FIG. 5 is a schematic sectional view showing a state in which a lower mold has been turned 180° in a third step in the production method;

FIG. 6 is a schematic sectional View concerning a fourth step in the production method; and

FIG. 7 is a schematic sectional view concerning a fifth step in the production method.

### DETAILED DESCRIPTION OF EMBODIMENTS

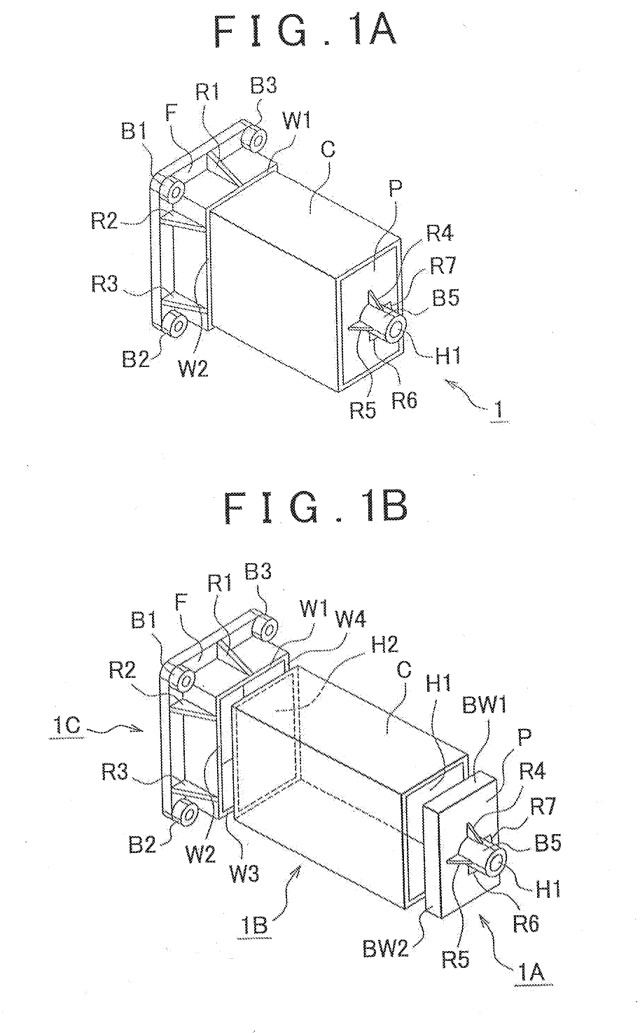

Hereinafter, embodiments of the invention (referred to as “the embodiments”) will be described with reference to FIG. 1 to FIG. 7. The embodiments include a first embodiment regarding the structure of the component part of the invention, a modification thereof, and a second embodiment regarding the production method for the component part of the invention. Incidentally, in this specification, the component part shown in FIG. 1 will be described as a representative example. However, the invention is not limited to this component part, but allows various changes, modifications, etc., to be made as appropriate by a person having ordinary skill in the art.

### FIRST EMBODIMENT

FIG. 1A and FIG. 1B show a structure 1 of a frame component part for attaching, for example, a component part (not shown, and hereinafter referred to as “component part Y”) to a component part (not shown, and hereinafter referred to as “component part X”). Furthermore, FIG. 1A shows a perspective view of the structure 1 of the component part in which a flange portion 1C of a complicated shape for attaching the frame component part to the component part X, a plate 1A equipped with a boss for attaching the component part Y to the frame component part, and a tube 1B of a simple shape are integrated together. FIG. 1B shows an exploded perspective view in which the three components of the component part 1, that is, the plate 1A for attaching the component part Y, the tube 1B of a frame portion that supports the component part Y, and the flange portion 1C that is fixed to the component part X are separated from each other.

The tube 1B is a skeleton member formed by impregnating a thermoplastic resin into a continuous reinforcement fiber prepared in a woven state by plain weaving, skip plain weaving, twill weaving, satin weaving or the like of a fiber provided for increasing the rigidity. This tube 1B has a rectangular box shape whose four sides are formed by thick-wall rectangular plates so that an opening whose plane is perpendicular to the longitudinal direction of the tube 1B is formed within the box shape. Thus, although the tube 1B has an elongated shape, its rigid strength is high due to the skeleton members contained therein. The fiber for increasing the rigidity of the tube 1B is preferably a continuous fiber made of an organic or inorganic material, such as carbon, aramid, glass, etc., or a long fiber whose length is 10 mm or greater. Besides, the thermoplastic resin used for the tube 1B is preferably a thermoplastic resin capable of being relatively easily SRIM-molded, such as PA6, PA11 or PA12, or cyclic PBT, cyclic PET, cyclic PEN, etc. Among these, PA6 is widely used and achieves cost reduction, and therefore may be employed because of its advantage in material cost. These thermoplastic. resins are relatively easily obtained as polymerized resins by polymerization reaction of their raw material monomers or oligomers. Since the monomers or oligomers are low in molecular weight, and therefore much lower in viscosity than a Molten liquid of a polymer, the monomers or oligomers easily impregnate the foregoing fiber provided for increasing the rigidity. Therefore, the use of monomers or oligomers, compared with the use of a polymerized thermoplastic resin, achieves an increased proportion of reinforcement fiber, and improves the wettability between the fiber and the resin and therefore improves the strength.

In the case where the reinforcement fiber of the tube 1B is, for example, carbon fiber, the proportion of the carbon fiber in the entire tube 1B is preferably 10 wt % to 70 wt %. if the proportion of the carbon fiber is less than 10 wt %, the reinforcement effect is inconveniently small compared with the labor required. On the other hand, if the proportion of the carbon fiber is greater than 70 wt %, the moldability deteriorates, or the rigid strength declines, or excessive fiber is sometimes exposed in a surface of the component part 1. However, the range of the proportion can be changed as appropriate depending on the kind of fiber used or other conditions, and is therefore not limited to the foregoing range. Incidentally, instead of using a tubular member such as the tube 1B, a band-shape Material may be wound on side surfaces of a mold so as not to unroll, so that a tubular member is accordingly formed.

The plate 1A is equipped with a boss B5 for attaching the component part Y to a center of a flat surface P of the plate 1A. The cylindrical tubular boss B5 is perpendicular to the flat surface P, and is molded integrally with the flat surface P. Besides, in order to support the boss B5 from four directions, ribs R4 to R7 of a right triangular shape are molded integrally with the flat surface P and the boss B5. In the case where a PA resin, such as PA6, PA11, PA12, etc., is used for the frame tube 1B, the thermoplastic resin for use in the plate IA is preferably a polyamide-based thermoplastic resin, such as PA6 [Nylon6™], PA11 [Nylon11™], PA12 [Nylon12™], PA66 [Nylon66™], etc., or an alloy thereof. Among these, PA6 is widely used and achieves cost reduction, and therefore may be employed because of its advantage in material cost. Incidentally, in the case where cyclic PBT, cyclic PET or cyclic PEN is used for the tube 113, it is preferable to use PBT, PET or PET, or an alloy thereof for the plate 1A. A reason for this is to weld the tube 1B and the plate 1A by using the same type of resin for the tube 18 and the plate 1A.

The flange 1C is made by using substantially the same thermoplastic resin or resin alloy as the plate 1A, and the shape thereof is a picture frame shape. Then, in the four corner of the flange 1C, there are formed cylindrical tubular bosses B1 to B4 (B4 is not shown) through which fixing bolts are to be inserted; and ribs R1 to R6 (R4 to R6 are not shown) of a right triangular sectional shape for increasing the rigid strength. A surface of each of the ribs R1 to R6 of a right-triangular sectional shape which includes the shorter one of the two sides of the right triangular shape other than the hypotenuse is integrated with a surface of a picture frame portion F, and a surface of each of the ribs R1 to R6 which includes the longer one of the two sides of the right triangular shape other than the hypotenuse is integrated with a surface of a corresponding one of thick walls W1 to W4 that are perpendicular to the surface of the picture frame portion F. The thick walls W1 to W4 and the picture frame portion F are integrally formed so that they are supported by the ribs R1 to R6. Thick walls W1 to W4 surround an opening portion H2 of the tube 1B, and form a rectangular sectional shape, in other words, form form an opening of a rectangular sectional shape. Thus, the flange 1C includes complicated structures with various projection-and-depression structures.

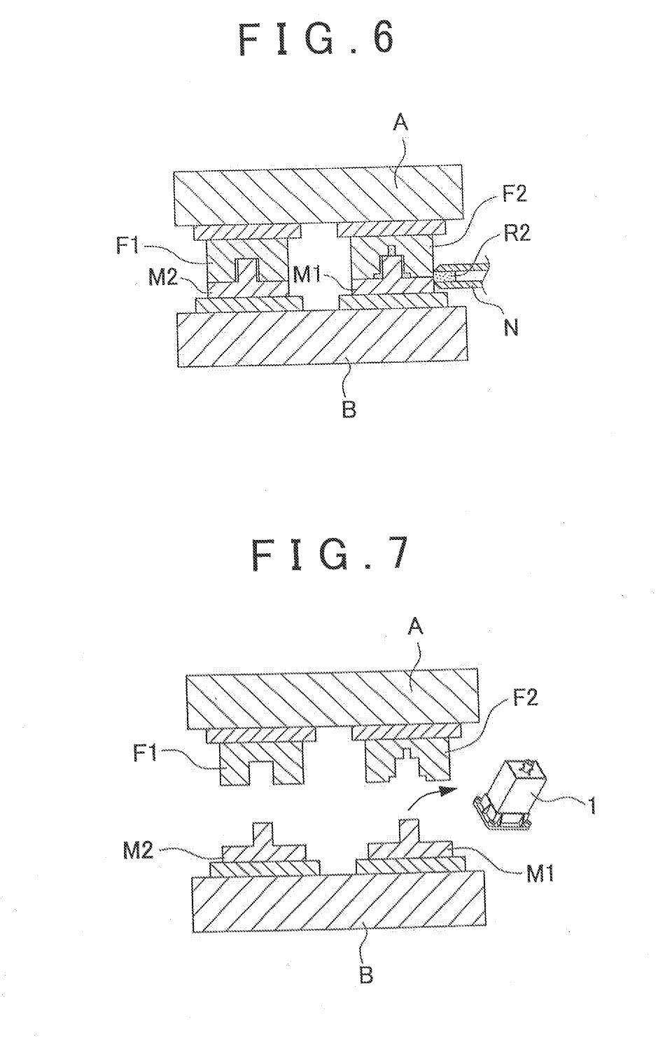

The plate 1A and the flange 1C may be formed from only a thermoplastic resin or a thermoplastic resin alloy. However, in order to further increase the rigid strength, it is preferred to contain a large amount of a short-length filler material in the thermoplastic resin or the thermoplastic resin alloy. As the short-length filler material, it is preferred to use, for example, a glass short-length fiber formed by injection by injection molding. The proportion of the filler material to the total amount of material is preferred to be greater than 0 wt % and less than or equal to 50 wt %. A reason for containing the filler material in the thermoplastic resin at a relatively low percentage as mentioned above is that since the plate 1A and the flange 1C include complicated projection-and-depression structures, such as bosses, ribs, etc., as mentioned above, the material that is to fill in according to the projection-and-depression surfaces of the mold needs good fluidity, if the amount of the filler material is larger than 50 wt %, there arises a possibility of deterioration of the fluidity of the thermoplastic resin. Besides, there is an increased possibility of the filler material clogging an injection nozzle N (see FIG. 6) during the injection molding described below. Incidentally, the filler Material for use herein may be a short-length fiber material made of carbon, aramid [Kevlar™]; or other organic or inorganic materials. In the case where good fluidity is secured by a surface treatment of the fiber or by a resin additive, the range of the amount of the material is not limited to the foregoing preferred range, but the upper limit of the range in percentage by weight can be thither increased.

### MODIFICATIONS

As a modification of the foregoing first embodiment, a form in which PA6 is used as the thermoplastic resin of the tube 1B, and a resin that has weldability with PA6 and low water absorbency, for example, PA66, is used as the thermoplastic resin of the plate 1A and/or the flange 1C and the entire periphery of the tube 18 is covered with PA66 will be illustrated as an example. This modification makes it possible to use PA6 as a material of the SRIM process even for a component part about which water absorption can become a problem.

Besides, the materials of the tube 1B and of the plate 1A and/or the flange 1C are not only the combination of PA6 and PA66, but may also be combinations of PA6 and a resin that has weldability with PA6 and has low water absorbency, such as a combination of PA6 and PA11, a combination of PA6 and PA12, a combination of PA6 and PA46, etc. Besides, the materials of the tube 1B and of the plate 1A and/or the flange 1C may also be combinations of various kinds of polyamide-based resins and resins and alloy resins that have weldability with the polyamide-based resins and have low water absorbency.

### SECOND EMBODIMENT: METHOD OF PRODUCING STRUCTURE OF COMPONENT PART

A second embodiment relates to a production method for the component part 1. This embodiment will be described with reference to FIG. 1 and FIGS. 2 to 7 through the use of a representative example in which PA6 is used as the thermoplastic resin.

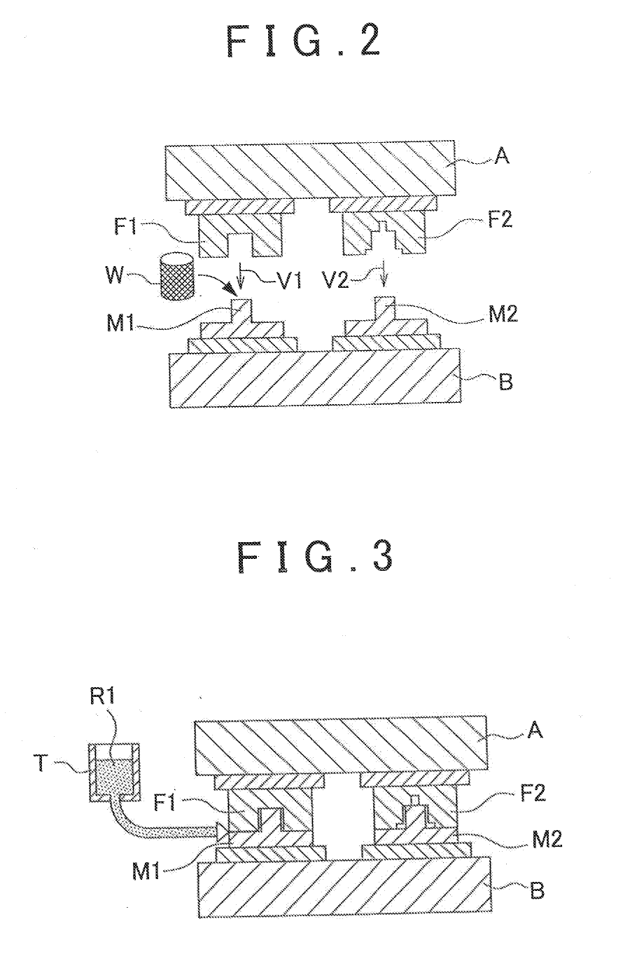

In the second embodiment, what are firstly prepared are molds A and B as shown in FIG. 2 that include a columnar first male die M1 whose punch driving direction V1 coincides with a vertical direction, a columnar second male die M2 whose punch driving direction V2 coincides with the punch driving direction V1, that is, whose center axis is parallel with a center axis of the first male die M1, a first female die F1 that is fittable to the first male die M1 with a certain clearance (hereinafter, referred to as “first clearance”) from the first male die M1 and that has a rectangular parallelepiped or cylinder-shape cavity, and a second female die F2 that is fittable to the second male die M2 with a certain clearance (hereinafter, referred to as “second clearance”) therefrom and that has, at an upper position, a production-and-depression shape cavity (incidentally, in the case where the component part shown in FIG. 1 is to he produced, the second female die F2 whose cavity surface corresponds to the plate 1A, and the first male die M1 that corresponds to the flange 1C are used). The mold A is driven up and down in the vertical direction by a hydraulic cylinder or the like, and the mold B is horizontally pivoted about an axis of symmetry between the center axis of the first male die M1 and the center axis of the second male die M2 by a turn table. The first and second male dies M1 and M2 are disposed on a base table that is rotatable about the vertical axis of symmetry. The first and second male dies Mi and M2 are disposed symmetrically about the vertical axis. If the first male die M1 is turned 180° about the rotation axis O by the turn table, the first male die M1 is positioned at the position that is occupied by the second male die M2 before the turning.

### FIRST STEP: FIG. 2

Firstly, a cylindrical tubular fiber material W obtained by forming into a cylindrical tubular shape a continuous fiber material obtained by plain weaving of rigid-increasing fiber (e.g., carbon fiber) is placed over the first male die M1 so that the entire side portion of the first male die M1 is coated with the cylindrical tubular fiber material W. The height of the cylindrical tubular fiber material W set equal to or slightly lower than the height of the first male die M1. Incidentally, instead of fabricating a tubular continuous fiber material in a cylindrical tubular shape beforehand, it is also permissible to wind a band-shape continuous fiber material on the first male die M1 and fix the wound hand-shape continuous fiber material.

### SECOND STEP: FIG. 3

Next, the mold A is driven downward in the vertical direction so that the first female die F1 and the second female die F2 are fitted to the first male die M1 and the second male die M2, respectively, and then a molten thermoplastic resin R1 (e.g., PA6 monomers) housed beforehand in a tank T is poured into a site of the cylindrical tubular fiber material W.

At this time, it is preferable that the temperature of the molds A and B be set at 140° C. to 170° C. and the melt temperature of the thermoplastic resin (ε-caprolactam) be set at 80° C. to 100° C. If the temperature of the molds A and B is lower than 140° C., sufficiently high molecular weight cannot be achieved. On the other hand., if the temperature of the molds A and B is higher than 170° C., the resin solidifies before completely filling the molds. Besides, if the melt temperature of ε-caprolactam is lower than 80° C., the viscosity thereof becomes considerably high. If the melt temperature of ε-caprolactam is higher than 100° C., the polymerization reaction considerably progresses leading to high viscosity. Incidentally, in the case where the impregnation with ε-caprolactam needs more time depending on. the density of a woven fabric of the cylindrical tubular fiber material W of the tube 1B, it is permissible to set the mold temperature and the melt temperature of the thermoplastic resin at about equal levels and then increase the mold temperature after the impregnation is finished. In this manner, the molten thermoplastic resin R1 impregnates the cylindrical tubular fiber material W due to the capillary phenomenon.

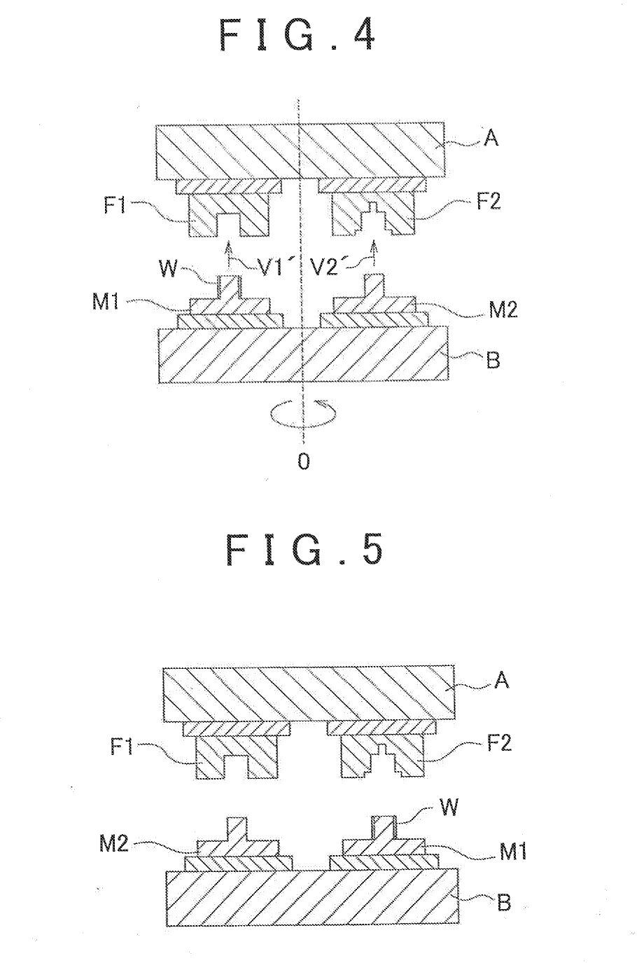

### THIRD STEP: FIGS. 4 AND 5

Next, at a point in the course of the polymerization reaction of the thermoplastic resin R1, the mold A is driven vertically upward V1′ (V2′) (FIG. 4). After the first female die F1 and the second female die F1 have completely separated from the first male die M1 and the second male die M2, respectively, the mold B is turned 180° about the rotation axis, and then is stopped (FIG. 5).

### FOURTH STEP: FIG. 6

Similarly to the first step, the mold A is driven downward in the vertical direction (i.e., in the direction V1). In the fourth step, however, the first female die F1 is fitted to the second male die M2 and, simultaneously, the female die F2 is fitted to the first male die M1. Then, the thermoplastic resin in the molten state is injected from the nozzle N of an injection gun into a cavity that is a projection-and-depression shape space. As described above, the thermoplastic resin may contain an appropriate amount, for example, 30 wt %, of a filler material, such as a short-length glass fiber or the like, in order to increase the rigid strength. At this time, in order to accelerate the polymerization of the resin that contains a cylindrical tubular fiber material impregnated with the thermoplastic resin when the SRIM process is employed in the second step and the third step, it is preferred to set the mold temperature at 150° C. or higher.

### FIFTH STEP: FIG. 7

Finally, the nozzle N of the injection gun is moved apart from the first male die M1 and the second female die F2, and the molds A and B are cooled. After the thermoplastic resin cools and solidifies, the mold A is driven vertically upward to secure between the mold A and the mold B at least a space that allows the component part 1 to be taken out, and then the component part 1 is removed from the first male die M1.

According to the production method for the component part 1 which include the foregoing first to fifth steps, it is possible to obtain the component part 1 as described above in conjunction with the first and second embodiments. Particularly in this production method, while the thermoplastic resin impregnated in the cylindrical tubular fiber material laid on the first male die M1 is undergoing the polymerization reaction, the second female die M2 provided with the projection-and-depression shape cavity C can be fitted to the first male die M1, and immediately subsequently the thermoplastic resin for filling the cavity C can be injected and molded.

As a result, the temperature needed for the polymerization reaction (change to larger molecules) of the thermoplastic resin can be maintained and, at the same time, the injection molding time can be contained within the time of the polymerization reaction of the thermoplastic resin. In consequence, the lead time in the entire production process of the component part 1 can be reduced, and the production process proceeds to the subsequent step (injection molding) before the cylindrical tubular fiber material (skeleton member) impregnated with the thermoplastic resin which is obtained by the SRIM process has a low temperature. Therefore, there is no need to heat the skeleton member in order to secure weldability, and the component part 1 can be produced at high efficiency and with good productivity.

As can be understood from the foregoing embodiments to the invention, it is possible to provide a component part made of a composite material that has advantages of both a continuous fiber-reinforced material (FRP) excellent in rigid strength and a thermoplastic resin (that contains a short fiber-reinforced material and/or a filler material according to need) excellent in the freedom in shape and excellent in the productivity, and to provide a production method for the component part.

General descriptions of the foregoing embodiments of the invention will be given below.

The embodiments of the invention relate to fiber-reinforced composite material-made component part in which a first resin member that essentially contains a fiber for increasing the rigid strength and a second resin member that does not necessarily need to contain the foregoing fiber are integrated. This component part has a structure in which the first resin member is made of an FRP obtained by impregnating the rigid strength-increasing fiber with a thermosetting resin by the SRIM process, and in which the second resin member contains a thermoplastic resin, and in which the first resin member and the second resin member are integrated together by injection molding through the use of the thermoplastic resin.

In this component part, the first resin member may be an elongated tubulous portion that is provided with a good rigid strength by the SRIM process, and the second resin member may be such a portion as a plate or a flange having a complicated projection-and-depression shape, for example, a shape that includes ribs, bosses, etc. Using a molten thermoplastic resin, each of the two opposite end openings of the elongated tubulous portion may be covered with a plate or a flange, and the first resin member and the second resin member may be integrated together by injection molding. In this component part, the first resin member may be a tube member in which a fiber woven fabric is impregnated with PA6, and the second resin member may be a projection-and-depression shape structural member that covers side surfaces of the tube member and that is formed while covering the two openings of the tube member.

In this component part, the second resin member may contain a polyamide-based thermoplastic resin that has weldability with the PA6 and that is lower in water absorbency than the PA6. Due to this construction, the first resin member and the second resin member can be firmly adhered and integrated together, and the structure of the component part can be provided with water resistance.

In this component part, the thermoplastic resin of the second resin member may be PA46 or PA66. According to this construction, since each of PA46 and PA66 has compatibility and weldability with PA6 of the first resin member, the resins of the two structures will well dissolve and integrate with each other at the interface between the structures, and will achieve high adhesion strength.

In this component part, the second resin member may further contain an organic or inorganic short-length filler material at a weight percentage that is greater than 0 wt % and lower than or equal to 50 wt %. Due to this construction, the second resin member is also provided with right strength.

Furthermore, the embodiments of the invention relate to a production method in Which, by using a mold structural body that includes a rectangular parallelepiped-shape or cylinder-shape first male die whose punch driving direction is along a vertical direction, a columnar second male die disposed in parallel with the punch driving direction, a first female die that has a rectangular parallelepiped-shape or cylinder-shape cavity and that is fittable to the first male die or the second male die, and a rectangular parallelepiped-shape or cylinder-shape second female die whose end surface has a projection-and-depression structure and which is fitted to the first male die or the second male die, a fiber-reinforced composite material component part in Which a cylindrical tube portion has a cavity that has the projection-and-depression structure is produced. This method includes: coating a side surface of the first male die with a fiber 25 woven fabric provided for increasing the rigid strength; fitting the first male die and the first female die to each other while maintaining a first clearance between the first male die and the first female die; heating the first male die and the first female die; pouring a thermoplastic resin in a molten state into the first clearance; forming a rectangular parallelepiped-shape or cylinder-shape tube member by impregnating the fiber woven fabric with the thermoplastic resin; separating the first male die and the first female die from each other after forming the tube member; fitting the first male die and the second female die to each other, with a second clearance maintained between the first male die and the second female die, while the thermoplastic resin is in a half hardened state; heating the first male die and the second female die fitted to each other; performing injection molding by pouring a thermoplastic resin in the molten state into the second clearance so that a projection-and-depression structure that corresponds to the projection-and-depression structure of the cavity is formed; and the tube member and the projection-and-depression structure are cooled and integrated together.

In this method, the first male die and the second male die may be of a cylinder-shape or rectangular parallelepiped-shape lower punch type, and the first female die may be of an upper punch type that has a cylinder-shape or rectangular parallelepiped-shape cavity space, and an upper portion of the second female die may have a projection-and-depression surface for forming a plate that is provided with a boss and a rib, and a lower portion of the second female die may have a projection-and-depression surface for forming a flange that is provided with a boss and a rib, and a component part whose upper and lower portions have a projection-and-depression structure and whose side surface is a cylinder side surface or a rectangular parallelepiped side surface may be made.

Besides, the invention is not limited to the foregoing embodiments. For example, although in the third embodiment, PA6 is used as the thermoplastic resin, a thermoplastic resin other than PA6 may also be used. In that case, it suffices that a person having ordinary skill in the art carries out the production method by adjusting the mold temperature and the melt temperature of the thermoplastic resin according to the thermoplastic resin used. Although in the third embodiment, the mold B is horizontally pivoted about the center axis O between the male die M1 and the male die M2 by the turn table, the mold A may instead be horizontally pivoted in the same manner so that the first male die M1 and the second male die M2 are appropriately positioned relative to the mold A.

While some embodiments of the invention have been illustrated above, it is to be understood that the invention is not limited to details of the illustrated embodiments, but may be embodied with various changes, modifications or improvements, which may occur to those skilled in the art, without departing from the scope of the invention.

1. A fiber-reinforced composite material-made component part comprising
a structure in which a skeleton member that is molded by a first injection molding process and that is made of PA6 as a first thermoplastic resin that is reinforced by a continuous fiber contained in the first thermoplastic resin, and a member that covers the skeleton member and that is made of a polyamide-based thermoplastic resin as a second thermoplastic resin that has weldability with the first thermoplastic resin and that is lower in water absorbency than the first thermoplastic resin are integrated by a second injection molding process.

2. The component part according to claim 1, wherein the second thermoplastic resin has compatibility with the first thermoplastic resin.

3. (canceled)

4. The component part according to claim 1, wherein the first injection molding process is a reaction injection molding process for a structural material.

5. The component part according to claim 1, wherein the second thermoplastic resin has high weldability with the first thermoplastic resin.

6. A method of producing a fiber-reinforced composite material-made component part in which a skeleton member that is formed by a first injection molding process and that is made by impregnating a tubular fiber with PA6 as a first thermoplastic resin, and a projection-and-depression structure that contains a polyamide-based thermoplastic resin as a second thermoplastic resin having weldability with the first thermoplastic resin and being lower in water absorbency than the first thermoplastic resin are integrated together by a second injection molding process, the method comprising
performing the second injection molding process immediately subsequently to molding of the skeleton member by the first injection molding process so that a polymerization reaction time of the first thermoplastic resin is contained in a time that is needed for the first injection molding process and the second injection molding process.

7. (canceled)

8. The method according to claim 6, wherein the second thermoplastic resin has compatibility with the first thermoplastic resin.

9. The method according to claim 6, wherein the first injection molding process is a reaction injection molding process for a structural material.
